(19) United States
(12) Patent Application Publication
(10) Pub. No.: US 2004/0230897 A1
(43) Pub. Date: Nov. 18, 2004

(54) Systems and methods for generating web sites

(76) Inventor: Markus Latzel, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/256,210

(22) Filed: Sep. 27, 2002

(51) Int. Cl. G06F 15/00

(52) U.S. Cl. 715/513

(57) ABSTRACT

A system and method for generating a web site having a content portion and a design portion is disclosed. A server separately stores the content portion of the web site in a content hierarchical structure and the design portion of the web site in a design hierarchical structure. The server generates the web site from the content portion and the design portion. A client edits a selected one of the content portion and the design portion of the web site.

### FIELD OF THE INVENTION

The invention relates to web sites, and in particular to systems and methods for editing web sites.

### BACKGROUND OF THE INVENTION

The Internet, and particularly the World Wide Web (also known as simply the “Web”) portion of the Internet, continue to gain in popularity. An important factor for maintaining the popularity of the Web is the creation and maintenance of web sites. In the infancy of the Web, web site content was limited to text and primitive graphics. However, as the popularity of the Web has grown, the amount, type, and currency of content published on web sites continue to expand.

The different types of content available on web sites and the need to continually update the content create challenges for web site designers and administrators. For example, an organization may have a web site that includes spreadsheet tables, lists of news items or other articles, text, and images (still or moving). In addition, an organization may require that its web site consume a data feed, such as a ticker displaying stock quotes. The same organization may require that the same content be published to a Hypertext Transfer Protocol (HTTP) site and a Wireless Application Protocol (WAP) site for mobile computing devices. Finally, the same organization may require that both sites be continually updated.

One known way to edit or update web sites is to replace the posted files, such as for example hypertext markup language (HTML) files, with updated files containing the new content. Because HTML combines content and design, this updating approach is time consuming as it requires replicating large amounts of information which do not change with the update, such as for example, the design elements which control how the content in the HTML file will be displayed on the web site.

Consequently, a number of known tools to assist developers separate content and design have been developed to streamline web site creation and maintenance. One such tool is Extensible Markup Language (XML), which allows developers to identify web site content by type, permitting web sites to function like database records. Although XML provides a tool for streamlining web site creation and maintenance, additional development is required to implement the XML framework. This has the disadvantage of requiring an organization to employ in-house web site developers and administrators.

Accordingly, there is a need for systems and methods to more conveniently edit and generate web sites. There is a further need to provide simplified automated editing of web sites, requiring less technical expertise.

### SUMMARY OF THE INVENTION

The present invention provides systems and methods which separate the content from the design of the web site, and allow the content and design to be edited independently. In its preferred embodiments, the present invention also provides the advantage of customized editors corresponding selected parts of the web site content and design to facilitate editing thereof. These customized easy to use interfaces allow the editing of the web site by members or employees who actually create the content displayed on the web site, thereby reducing the need for web site developers.

According to a first aspect of the invention, a system for generating a web site comprising a content portion and a design portion is provided. The system comprises:

a) a server adapted to generate the web site from at least the content portion and the design portion; and

b) a client adapted to communicate with the server, the client being adapted to edit a selected one of the content portion and the design portion of the web site.

Preferably, the server stores the content portion in a content hierarchical structure and the design portion in a design hierarchical structure, wherein the content hierarchical structure is separate from the design hierarchical structure.

According to a second aspect of the invention, a method of generating a web site comprising a content portion and a design portion is provided. The method comprises:

a) organizing the content portion into a content hierarchical structure comprising a plurality of content nodes and organizing the design portion into a design hierarchical structure comprising a plurality of design nodes;

b) selecting a predetermined node from the plurality of content nodes or the plurality of design nodes for editing; and

c) editing the data stored in the predetermined node.

Preferably, the method further comprises the step of providing a rule corresponding to the predetermined node, where the rule comprises preference information relating to the predetermined node.

According to a third aspect of the invention, a server for generating a web site comprising a content portion and a design portion is provided. The server being configured for communication with a client. The server comprises:

a) a database adapted to store the content portion and design portion in a hierarchical structure comprising a plurality of nodes, wherein the content portion is separated from the design portion;

b) a rule repository comprising at least one rule associated with a corresponding node, the at least one rule comprising preference information for the corresponding node; and

c) a client interface in communication with the rule repository and the database, where the client interface communicates the data stored in the corresponding node and the rule to the client.

### BRIEF DESCRIPTION OF THE DRAWINGS

The present invention will now be described by way of example only with reference to the accompanying drawings, in which:

FIG. 1 is a block diagram of a system according to the preferred embodiment of the present invention;

FIG. 2 is a screen shot showing an example of a tree structure of the content portion created by the present invention;

FIG. 3 is a screen shot showing an example of a tree structure of the design portion created by the present invention;

FIG. 4 is a block diagram of the preferred embodiment showing the client and server in more detail;

FIG. 5 is a flow diagram of the logic flow of the preferred embodiment; and

FIG. 6 is a flow diagram showing the completion of the logic flow of FIG. 5.

### DETAILED DESCRIPTION OF THE INVENTION

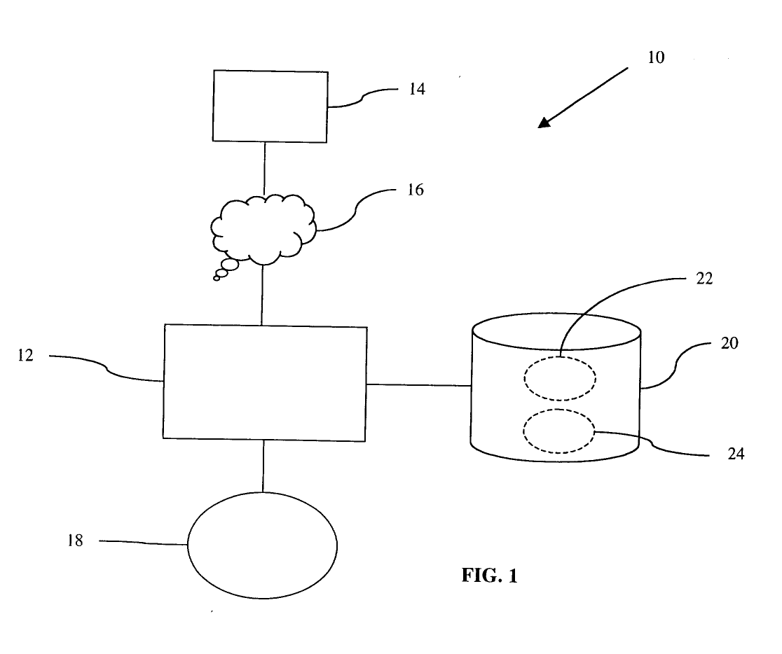

FIG. 1 shows a preferred embodiment of a system 10 according to the present invention. A server 12 communicates with a client 14 over any suitable network, such as the Internet 16. Although the client 14 and server 12 shown in FIG. 1 are each implemented on a standalone computing device capable of connecting to the Internet 16, it will be understood by those skilled in the art that the client and server may be implemented as one or more software programs running on a single computer.

Continuing to refer to FIG. 1, the client 14 and server 12 connect to the Internet 16 by telephone modem, cable modem, wireless modem, DSL modem, local area network (LAN), wide area network (WAN), T1, or any other means known in the art.

The server 12 is capable of generating a web site 18, as discussed in more detail below. As used herein, “web site” means one or more related web pages which are on-line to the Internet. As used herein, “web page” means any functionality or content which is made available over the wired or wireless Internet by a server or other computer, including without limitation, HTML documents, executable scripts, data feeds, databases, web services, web sites for Internet-enabled wireless devices, such as cell phones or personal digital assistants (e.g. Wireless Application Protocol sites).

Continuing to refer to FIG. 1, the information presented on the web site 18 is stored on a database 20 in communication with the server 12. The database 20 may be loaded on a separate computing device or may reside locally on the server 12. Preferably, the database 20 is a hierarchical database which stores the content portion 22 separately from the design portion 24 for the web site 18. As used herein “content” means the information presented on the web site 18, including without limitation text of any form, graphics (moving or still), programmatic functionality (e.g. web services), data tables and online form definitions. “Design” means information which determines how the content is rendered or presented, including without limitation formatting, layout, menu entries, navigation tools and graphics.

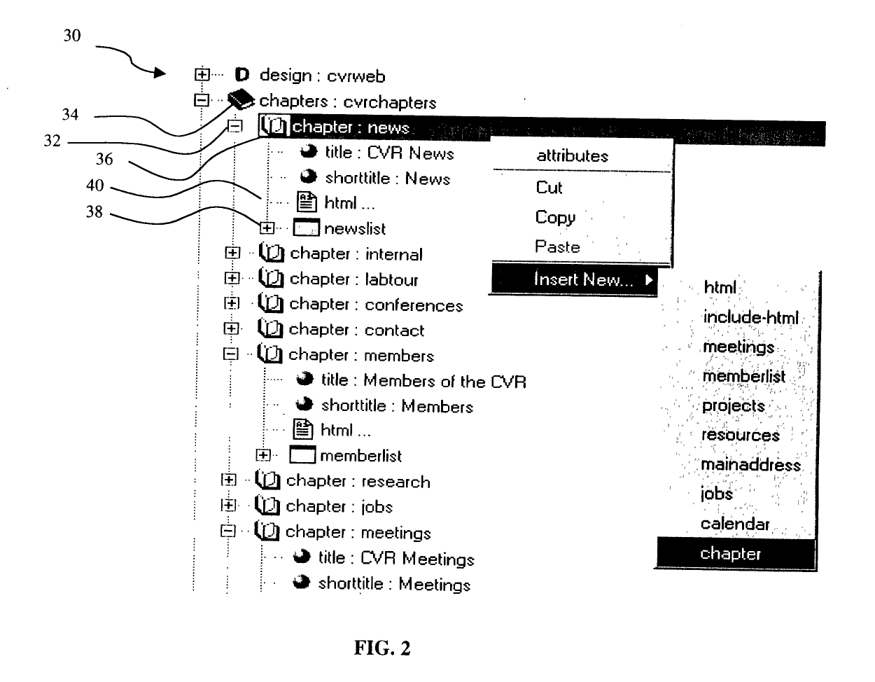

Referring now to FIGS. 1 and 2, the content portion 22 and the design portion 24 are preferably each organized in a tree structure 30, having a plurality of branches or nodes 32. Each node (parent node) may have one or more nodes (child nodes) stored therein, which in turn may have its own child nodes, and so on. For example, the “chapter: news” node 36 is a child of “chapters: cvrchapters” node 34 which is the root node for the content portion 22. In turn, the “chapter: news” node 36 is the parent of node “newslist” 38. The “newslist” node 38 contains therein the news item documents (such as HTML pages) to be displayed on the web site 18.

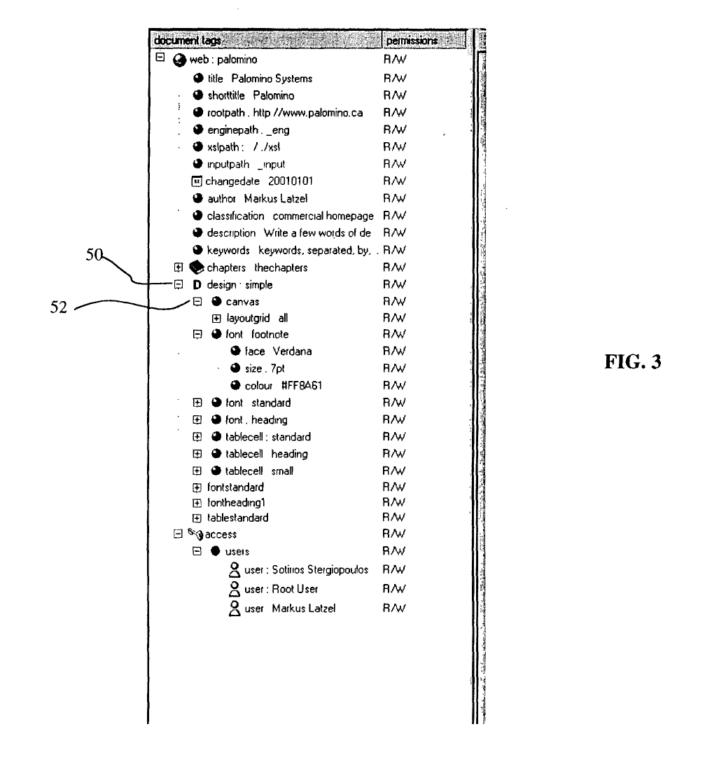

Referring now to FIGS. 1 and 3, by way of example, the “design:simple” node 50 is a root node for the design portion 24 of the web site 18. The root node 50 for the design portion has a “canvas” child node 52, which stores the layout grid information for the web site 18.

Referring now to FIG. 1, the server 12 communicates with the database 20 to retrieve the content portion 22 and design portion 24. The server 12 then renders the content portion 22 in accordance with the information in the design portion 24 to publish the web site 18 (as discussed in more detail below). Although in this embodiment, the entire design portion 24 is below the root design node 50, additional design nodes (not shown) may be added within the content portion 22 of the tree structure 30, to provide users with alternative designs for a given content portion 22.

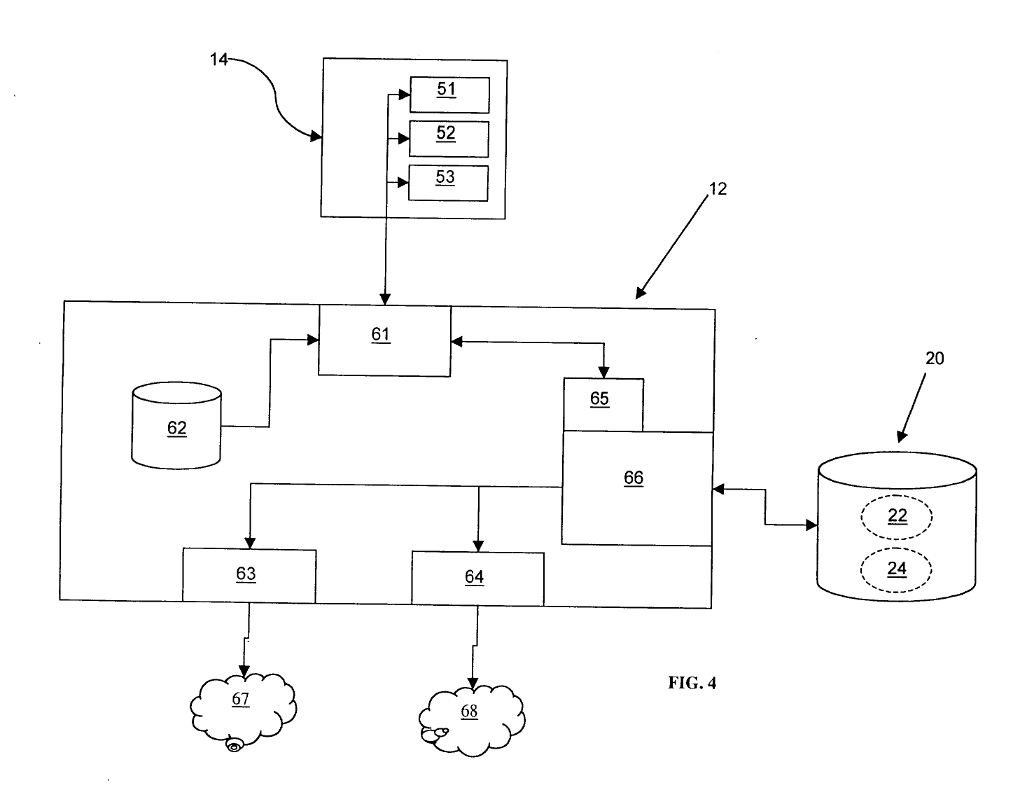

Referring now to FIGS. 2 and 4, the server 12 communicates with the client 14 via a client interface 61, which translates HTTP requests from the client 14 into JAVA function calls to a concurrency control module 65 and a rule repository 62. The rule repository 62 stores a number of rules in a list of XML documents, which may be stored in any suitable fashion, such as secondary storage (e.g. a hard drive) or in memory. The client interface 61 may query a single rule or multiple rules at once. Each node type in the content portion 22 or design portion 24 of the database 20 has preferably one rule associated with it. For example, each chapter node, such as the “chapter:news” node 36, has a rule associated with it, and each HTML node 40 has another rule associated with it. A rule provides preferences for each node type. For example, the preferences may include the type of editor to be used to edit the particular content node type. The various editors, such as editors 51, 52, 53 may be part of the client 14. For example, editor 51 may be a word processor, editor 52 may be a spreadsheet, and editor 53 may be an image editor. It will be understood by those skilled in the art that any suitable number and type of editors may be part of the client 14. Alternatively, the selected editor may be downloaded from the server 12 or a third-party editor, which is activated for the purpose of editing a particular node.

A rule may also include preferences, such as permissions for viewing or modifying the data associated with a particular node type. These permissions include access for single users or groups of users. Also, rules contain information about the appearance and behavior of nodes within the client interface 61. By way of example, the node type “chapter” specifies chapter:news 36 is to be displayed with an open book symbol, as shown in FIG. 2. It will be understood by those skilled in the art that the rule may include any other type of information suitable for managing, editing, or controlling access to information in a node type.

Referring now to FIG. 4, the server 12 communicates with the database 20 via a database interface 66, which translates function calls from the client interface 61 into access function calls for the database 20. A concurrency control module 65 communicates with the database interface 66 and the client interface 61. The concurrency control module 65 controls multiple, simultaneous user accesses to the database 20. The concurrency control module 65 also checks against access restrictions imposed by the permissions stored in the database 20.

Continuing to refer to FIG. 4, a rendering engine 63 and a structure engine 64 communicate with the database interface 66 to retrieve data from the content portion 22 and the design portion 24 of the database 20. The rendering engine 63 creates code for web pages from the content portion 22 and design portion 24 of the database 20. This code may be markup language (HTML, XML, WML) but may also include RTF, PostScript, PDF, or JavaScript. It will be understood by those skilled in the art that the rendering engine 63 may generate any type of output, including without limitation, images, database, or web services. The structure engine 64 creates control elements for generating the web pages from the design portion 24. These control elements may include file-copying operations, image file creation and transformation, file access permissions, directories, configuration files for a web server or executable scripts.

The logic of the present invention may be contained on a data storage device with a computer readable medium, such as a computer diskette. Alternatively, the instructions may be stored on a magnetic tape, conventional hard disk drive, electronic read-only memory, optical storage device, or other appropriate data storage device or transmitting device thereby making a computer program product, i.e., an article of manufacture according to the invention. In an illustrative embodiment of the invention, the computer-executable instructions may be lines of Java code.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its preferred embodiment by a machine component that renders the program elements in a form that instructs a digital processing apparatus (for example, a computer) to perform a sequence of function steps corresponding to those shown.

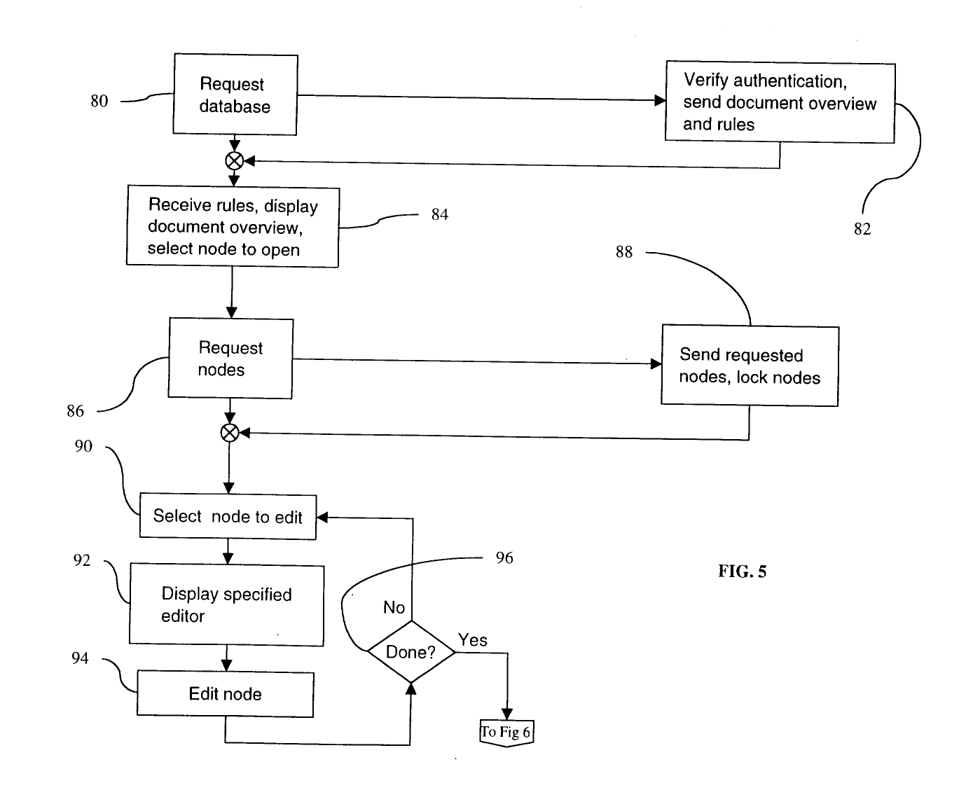

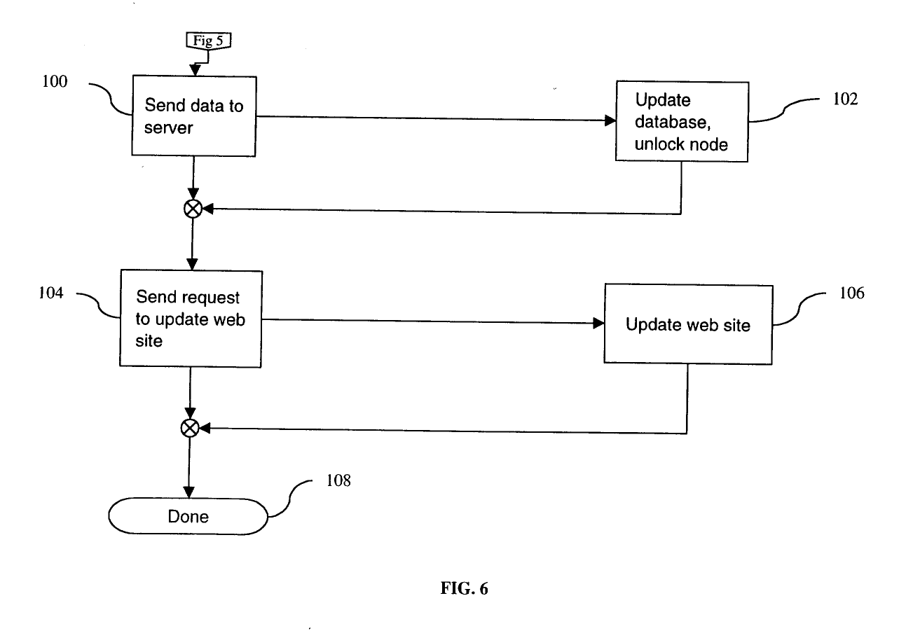

FIGS. 5 and 6 show a flow chart of a typical web site maintenance process, and is not intended to be limiting. The boxes in the left column of the Figures show client-side processes, while the right shows server-side processes.

The logic flow of the present invention will now be described with reference to FIGS. 4, 5 and 6. The flow begins at box 80, where the client 14 requests access to the database 20 via preferably a HTTP request. Although, for clarity, only one database is shown in FIGS. 1 and 4, the server 12 may administer several web sites, and each web site may have its own database. In such an embodiment, only users of a particular web site may have access to the particular database which corresponds to that web site. The request is directed to the server 12 which communicates with the database 20. The request may include an identifier for the database 20, as well as the user name and password to authenticate the user in order to ensure that the appropriate user accesses the database 20.

At step 82, client interface 61 of the server 12 receives the client request sent over the Internet 16, including the authentication information. The client interface 61 communicates the authentication information to the concurrency module 65, which verifies the authentication information by requesting that the database interface 66 retrieve the correct authentication from database 20 and by comparing it to the authentication information received from the client 14. Upon successful authentication, the database interface 66 preferably requests a skeleton overview of the content and design portions 22, 24 using XML Query Language (XQL). The skeleton overview is preferably a tree structure of the content and design portions 22, 24 of the database 20, showing the major nodes, such as for example, nodes 36, 38, 50, and 52 (shown in FIGS. 2 and 3). It will be understood by those skilled in the art, that the skeleton overview may include all of the nodes or any portion of the nodes in the tree structure. The client interface 61 receives the skeleton overview and sends it to the client 12.

In addition, the client interface 61 queries the rule repository 62 for the rules relevant to the database identifier, and sends these rules to the client 14.

In the event that the authentication information is not correct or a non-existent user or non-existent database identifier is provided, an appropriate error message is returned to the client interface 61, which translates the code into an HTTP error message returned to the client 14. The client 14 will then display the error message to the user.

At step 84, the client 14 preferably stores the rules received from the server 12 and displays the skeleton overview. The user then selects a node to retrieve from the skeleton overview. At step 86, the client 14 sends a request to the server 12 to retrieve the data in the selected node and all its child nodes (if applicable).

At step 88, the server 12 sends the requested data and locks the selected node (and all its child nodes if applicable) against write access by other users. For example, if the user chooses the newslist node 38 (shown in FIG. 2), the server 12 sends all of the newslist items in that node to the client 14, and locks the node against write access by other users.

At step 90, the user chooses a particular node to edit. In the above example, the user selects a specific news item from the list of news items in the newslist node 38.

At step 92, the client 14 accesses the rule for the selected node type, loads the editor specified in the rule, and displays the retrieved data from the selected node in the editor. In the above example, the client 14 displays the editor, such as a word processing editor 51, which has been specified in the newslist rule and displays the selected newslist item in the editor 51. At step 94, the user edits the data in the selected node.

When the user finishes editing the selected node, the logic flow moves to decision diamond 96, where the client 14 determines whether the user is finished editing the database 20 for the web site 18. This may be indicated by the user by selecting the “save”, “close document” or “exit application” option on the client 14. If one of these occurs, the logic flow moves to FIG. 6. If not, the flow returns to step 90, and steps 90-96 are repeated for the subsequent node selected by the user.

Referring now to FIGS. 4 and 6, the client 14 sends the updated data to server 12 at step 100. At step 102, the server 12 updates the database 20 and unlocks the locked nodes. At step 104, the user via the client 14 sends a command to the server 12 to update the web site 18. At step 106, the rendering engine 63 and the control structure engine 64 generate the web pages 67 and control elements 68, respectively, for the web site 18. Preferably, the server 12 does not host the web site, although it will be understood by those skilled in the art that the server 12, could host the web site 18, and such a modification is within the scope of the present invention. Preferably, the server 12 sends the web pages 67 and control elements 68 to a remote web server (not shown) which hosts the web site 18. This transfer may be achieved using the File Transfer Protocol (FTP) as is known in the art.

The present invention provides numerous advantages over the prior art. Specifically, the separation of the content and design portions of the web site into discrete hierarchical structures greatly simplifies editing of the web site and permits the users who actually create the content to update the web site, thereby reducing reliance on web site administrators. These advantages make complex web sites which provide large amounts of information much more affordable for smaller organizations which cannot afford a large staff of web site administrators. By separating design from content, the present invention simplifies the creation for additional web-based protocols or channels for the same content, such as for example WAP web sites or voice web sites. Specifically, such additional protocols and channels do not require duplication or additional instances of the content portion 22. Instead they require only the creation of additional design portions 24 which are all associated with one content portion 22. Unlike prior art systems which may require the same content change to be made to a number of duplicate instances of the same content, the present invention requires only changing the content portion 22 once, for the change to be reflected in the various channels.

In addition, the present invention simplifies editing of web pages so that it can be carried out by the member of an organization who creates the content, thereby reducing the need to hire web site developers and administrators. Specifically, rules associated with each node type in the content and design portions facilitate the editing of the web pages by, for example, automatically loading the appropriate editor for the content type in the selected content node.

Another advantage of the present invention is the hierarchical structure of the web site data to facilitate searching. Known Internet searching techniques require comparison of a search string with all of the data on the web site. The present invention allows appropriately configured intelligent agent software, such as a search bot, to access the preferences stored in the rule associated with a specific node in order to determine whether the data in that node is relevant to the search. Accordingly, the search will be made much more efficient by allowing the agent software to avoid searching data stored in nodes which have been determined by the agent software to be not relevant to the search, thereby avoiding the need to search the entire web site.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A system for generating a web site comprising a content portion and a design portion, the system comprising:
a) a server adapted to generate the web site from the content portion and the design portion; and
b) a client adapted to communicate with the server, the client being adapted to edit a selected one of the content portion and the design portion of the web site.

2. The system of claim 1, wherein the server is adapted to store the content portion in a content hierarchical structure and the design portion in a design hierarchical structure, wherein the content hierarchical structure is separate from the design hierarchical structure.

3. The system of claim 2, wherein the client is adapted to display a selected one of the content hierarchical structure and the design hierarchical structure for editing thereof.

4. The system of claim 3, wherein the content and design hierarchical structures are tree structures, the content hierarchical structure having a plurality of content nodes and the design hierarchical structure having a plurality of design nodes.

5. The system of claim 4, wherein the client is adapted to display a predetermined editor corresponding to a selected node, the selected node comprising one of the content nodes or the design nodes.

6. The system of clam 5, wherein the predetermined editor is adapted to edit the selected node.

7. The system of claim 2, further comprising a database adapted to store the content portion and the design portion.

8. The system of claim 7 wherein the server further comprises:
a) client interface for communication with the client;
b) a rule repository in communication with the client interface;
c) a concurrency control module in communication with the client interface;
d) a database interface for communication with the database, the database interface being in communication with the concurrency control module;
e) a rendering engine in communication with the database interface; and
f) a structure engine in communication with the database interface.

9. The system of claim 8, wherein the rendering engine is adapted to generate the web site based on the content portion and design portion.

10. The system of claim 9, wherein the structure engine is adapted to generate at least one control element for the web site.

11. The system of claim 10, wherein the at least one control element is selected from the group of file access permission, directory configuration file, and executable script.

12. The system of claim 10, further comprising a web server in communication with the rendering agent and the structure engine, the web server being adapted to host the web site.

13. The system of claim 8, wherein the client comprises a plurality of editors, wherein one of the plurality of editors is the predetermined editor.

14. The system of claim 13, wherein the plurality of editors comprises a word processor, a spreadsheet, a database, and an image editor.

15. The system of claim 8, wherein the client interface is adapted to translate http requests from the client into JAVA function calls.

16. The system of claim 15, wherein the database interface is adapted to translate the JAVA function calls into database access function calls.

17. The system of claim 8, wherein the rule repository is adapted to store a rule for at least one node type.

18. The system of claim 17, wherein the rule comprises preference information for the at least one node type.

19. The system of claim 18, wherein the preference information is selected from the group consisting of type of editor, permissions for viewing the data, permissions for modifying the data, appearance of nodes, and behavior of nodes.

20. The system of claim 8, wherein the concurrency control module is adapted to control multiple user access to the database.

21. A method of generating a web site comprising a content portion and a design portion, the method comprising:
a) organizing the content portion into a content hierarchical structure comprising a plurality of content nodes and organizing the design portion into a design hierarchical structure comprising a plurality of design nodes;
b) selecting a predetermined node from the plurality of content nodes or the plurality of design nodes for editing; and
c) editing the data stored in the predetermined node.

22. The method of claim 21, further comprising providing a rule corresponding to the predetermined node, the rule comprising preference information.

23. The method of claim 22, wherein the preference information is selected from the group consisting of type of editor, permissions for viewing the data, permissions for modifying the data, appearance of nodes, and behavior of nodes.

24. The method of claim 22, further comprising, prior to step (c), automatically loading a predetermined editor specified in the rule.

25. The method of claim 24, wherein the data in the predetermined node is edited using the predetermined editor.

26. The method of claim 25, wherein the predetermined editor is selected from the group consisting of a spreadsheet, a word processor, a database, and an image editor.

27. The method of claim 21, further comprising, prior to step (b), displaying an overview of at least one of the content hierarchical structure and the design hierarchical structure.

28. The method of claim 27, wherein the content hierarchical structure and the design hierarchical structure are tree structures.

29. The method of claim 21, further comprising prior to step (a), separating the content portion and the design portion.

30. The method of claim 21, further comprising the step of generating the web site from the edited data.

31. The method of claim 21, further comprising, prior to step (b), authenticating the authorization of a user to edit the web site.

32. A server for generating a web site comprising a content portion and a design portion, the server being configured for communication with a client, the server comprising:
a) a database adapted to store the content portion and the design portion in a hierarchical structure comprising a plurality of nodes, wherein the content portion is separated from the design portion;
b) a rule repository comprising at least one rule associated with a corresponding node, the at least one rule comprising preference information for the corresponding node; and
c) a client interface in communication with the rule repository and the database, the client interface being adapted to communicate the data stored in the corresponding node and the rule to the client.

33. The server of claim 32, wherein the preference information is selected from the group consisting of type of editor, permissions for viewing the data in the corresponding node, permissions for modifying the data in the corresponding node, appearance of the corresponding node, and behavior of the corresponding node.

34. The server of claim 33, wherein the rule comprises instructions to the client to display the data in a predetermined editor, the predetermined editor being specified by the preference information.

35. The server of claim 34, wherein the predetermined editor is selected from the group consisting of a word processor, a spreadsheet, a database, and an image editor.

36. The server of claim 32, wherein the hierarchical structure is a tree structure.

37. The server of claim 32, further comprising a database interface in communication with the client interface and the database, the database interface being adapted to translate function calls from the client interface to database access function calls.

38. The server of claim 37, further comprising a concurrency control module in communication with the client interface and the database interface, the concurrency control module being adapted to control multiple user access to the database.
